(19) United States
(12) Patent Application Publication
(10) Pub. No.: US 2024/0017586 A1
(43) Pub. Date: Jan. 18, 2024

(54) COOLING MODULE FOR AN ELECTRIC OR HYBRID MOTOR VEHICLE, HAVING A TANGENTIAL-FLOW TURBOMACHINE

(71) Applicant: VALEO SYSTEMES THERMIQUES, La Verriere (FR)

(72) Inventors: Amrid MAMMERI, La Verriere (FR); Kamel AZZOUZ, La Verriere (FR); Sebastien GARNIER, La Verriere (FR); Issiaka TRAORE, La Verriere (FR)

(73) Assignee: VALEO SYSTEMES THERMIQUES, La Verriere (FR)

(21) Appl. No.: 18/251,461

(22) PCT Filed: Sep. 30, 2021
(86) PCT No.: PCT/EP2021/076990

§ 371 Date: May 2, 2023

(30) Foreign Application Priority Data
Nov. 4, 2020 (FR) FR2011326

(51) Int. Cl. B60H 1/00; B60H 1/32

(52) U.S. Cl. CPC B60H 1/004; B60H 1/3229; B60H 2001/3291

(57) ABSTRACT

The invention relates to a cooling module for an electric or hybrid motor vehicle, designed to have an air flow passing therethrough, and including: a primary front heat; a receiver dryer positioned in an upstream part of the cooling module considered in a longitudinal direction extending from the front toward the rear of the cooling module; and a deflector element. In the longitudinal direction of the cooling module, the receiver-dryer is positioned downstream of and facing the deflector element.

### TECHNICAL FIELD

The present invention relates to a cooling module for an electric or hybrid motor vehicle, having a tangential-flow turbomachine.

### BACKGROUND OF THE INVENTION

A cooling module (or heat exchange module) of a motor vehicle conventionally comprises at least one heat exchanger and a ventilation device which is designed to generate a flow of air in contact with the at least one heat exchanger. The ventilation device thus makes it possible, for example, to generate an air flow in contact with the heat exchanger, when the vehicle is stationary or running at low speed.

In motor vehicles with a conventional combustion engine, the at least one heat exchanger has a substantially square form, with the ventilation device then being a bladed fan, the diameter of which is substantially equal to the side of the square formed by the heat exchanger.

Conventionally, the heat exchanger is then placed facing at least two cooling openings, formed in the front face of the body of the motor vehicle. A first cooling opening is situated above the bumper, while a second opening is situated below the bumper. Such a configuration is preferred as the combustion engine also must be supplied with air, with the air intake of the engine conventionally being situated in the passage of the air flow passing through the upper cooling opening.

However, electric vehicles are preferably only provided with cooling openings situated below the bumper, even more preferably with a single cooling opening situated below the bumper.

This is because the electric motor does not need an air supply. Also, a decrease in the number of cooling openings and in the size thereof makes it possible to improve the aerodynamic characteristics of the electric vehicle. This also results in better range and a higher top speed of the motor vehicle. Thus, according to the requirements of the manufacturers, for electric and hybrid vehicles, in particular in order to improve the aerodynamic fineness, the height of the heat exchangers present in these cooling openings is led to be reduced, and their thickness is led to be increased.

However, the stacking of the heat exchangers in the direction of the flow of air passing through them means that each heat exchanger positioned upstream affects the performance of the exchanger(s) placed downstream.

### SUMMARY OF THE INVENTION

One of the objectives of the present invention is therefore to eliminate the disadvantages of the prior art at least partly, and to propose an improved cooling module which permits the best possible performance levels for the different heat exchangers.

The present invention thus relates to a cooling module for an electric or hybrid motor vehicle, said cooling module being designed to have an air flow passing through it, and comprising at least one heat exchanger and a receiver-dryer connected within a cooling circuit,

the receiver-dryer being positioned in an upstream part of the cooling module considered in a longitudinal direction extending from the front toward the rear of said cooling module, in the longitudinal direction of said cooling module, the receiver-dryer being positioned downstream of and facing a deflector element.

According to one aspect of the invention, the at least one heat exchanger positioned furthest upstream in the longitudinal direction of said cooling module and the receiver-dryer are arranged in the one same plane.

According to another aspect of the invention, the receiver-dryer is positioned in such a way that its axis is perpendicular to the axis of the height of said at least one heat exchanger

According to another aspect of the invention, the deflector element is a crossmember of a frame of a front-face shutoff device positioned upstream of the at least one heat exchanger.

According to another aspect of the invention, the deflector element is a cross-beam of the chassis of the motor vehicle, positioned upstream of the at least one heat exchanger.

According to another aspect of the invention, the cooling module comprises two heat exchangers which are positioned in the one same plane in the most upstream position in the longitudinal direction of said cooling module, the receiver-dryer being positioned between said heat exchangers.

According to another aspect of the invention, the cooling module comprises:
a first heat exchanger configured to be a condenser connected within a cooling circuit,
a second heat exchanger configured to be a low-temperature radiator connected within a thermal management circuit, and
a third heat exchanger configured to be a sub-cooler connected within the cooling circuit.

According to another aspect of the invention, the thermal management circuit comprises, in the direction of circulation of a heat-transport fluid:
a pump,
a first cooler, and
the second heat exchanger.

According to another aspect of the invention, the cooling circuit comprises, in the direction of circulation of a refrigerant:
a compressor,
the first heat exchanger,
the receiver-dryer,
the third heat exchanger,
a first expansion device, and
a second cooler.

According to another aspect of the invention, the cooling circuit comprises a bypass leg connected in parallel with the first expansion device and with the first cooler, said bypass leg comprising a second expansion device positioned upstream of a third cooler.

According to another aspect of the invention, the second heat exchanger and the third heat exchanger are positioned in the same plane upstream of the first heat exchanger considered in the longitudinal direction of said cooling module.

According to another aspect of the invention, the cooling module comprises a fourth heat exchanger configured to be a low-temperature radiator, and positioned downstream of the first heat exchanger in the longitudinal direction of said cooling module.

### BRIEF DESCRIPTION OF DRAWINGS

Further features and advantages of the present invention will become more clearly apparent on reading the following description, which is provided by way of non-limiting illustration, and from the appended drawings, in which:

FIG. 1 shows a schematic representation of the front of a motor vehicle in side view;

FIG. 2 shows a schematic depiction in perspective and in partial section of the front of a motor vehicle and of a cooling module,

FIG. 3 shows a schematic representation of thermal management circuits;

FIG. 4 shows a schematic depiction, in perspective and revealing some of the hidden detail, of a cooling module;

FIG. 5 shows a schematic depiction, in side view and revealing some of the hidden detail, of a cooling module according to a first embodiment; and

FIG. 6 shows a schematic depiction, in side view and revealing some of the hidden detail, of a cooling module according to a second embodiment.

### DETAILED DESCRIPTION OF THE INVENTION

In the various figures, identical elements bear the same reference numbers.

The following embodiments are examples. Although the description refers to one or more embodiments, this does not necessarily mean that each reference relates to the same embodiment, or that the features apply only to one embodiment. Individual features of different embodiments can also be combined and/or interchanged to provide other embodiments.

In the present description, certain elements or parameters can be indexed, such as, for example, first element or second element and also first parameter and second parameter or else first criterion and second criterion, etc. In this case, this is simple indexing to differentiate and designate elements or parameters or criteria that are similar but not identical. This indexing does not imply priority being given to one element, parameter or criterion over another and such designations can be interchanged easily without departing from the scope of the present description. Neither does this indexing imply a chronological order, for example in evaluating any given criterion.

In the present description, “placed upstream” is understood to mean that an element is placed before another relative to the direction of circulation of an air flow. By contrast, “placed downstream” is understood to mean that one element is placed after another with respect to the direction of circulation of a flow.

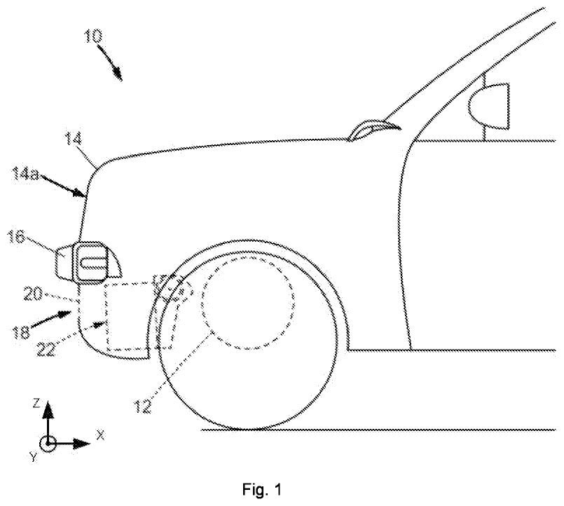

In FIGS. 1, 2, 4, 5 and 6, a trihedron XYZ is shown in order to define the orientation of the various elements relative to one another. A first direction, denoted X, corresponds to a longitudinal direction of the vehicle. It also corresponds to a direction opposite to the direction of forward movement of the vehicle. A second direction, denoted Y, is a lateral or transverse direction. Finally, a third direction, denoted Z, is vertical. The directions X, Y, Z are orthogonal in pairs.

In the present description, “low(er)” is understood to mean the position of an element relative to another in the direction Z determined above.

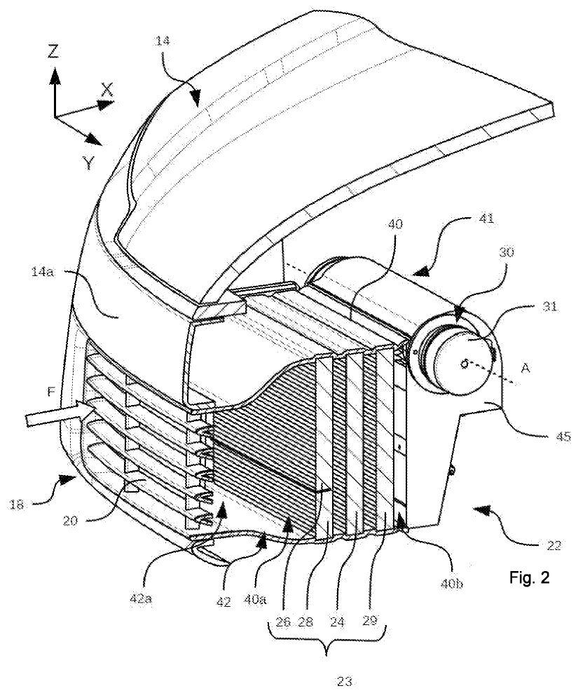

In FIGS. 1 and 2, the cooling module according to the present invention is illustrated in a functional position, that is to say when it is disposed within a motor vehicle.

FIG. 1 illustrates schematically the front part of an electric or hybrid motor vehicle 10 which can comprise an electric motor 12. In particular, the vehicle 10 comprises a body 14 and a bumper 16 which are supported by a chassis (not depicted) of the motor vehicle 10. The body 14 defines a cooling opening 18, i.e. an opening through the body 14. In this case, there is only the one cooling opening 18. This cooling opening 18 is preferably in the lower part of the front face 14a of the body 14. In the example illustrated, the cooling opening 18 is situated below the bumper 16. A grille 20 can be positioned in the cooling opening 18 to prevent projectiles from being able to pass through the cooling opening 18. A cooling module 22 is positioned facing the cooling opening 18. The grille 20 notably makes it possible to protect this cooling module 22.

As shown in FIG. 2, the cooling module 22 is designed to have an air flow F passing through it parallel to the direction X, and going from the front toward the rear of the vehicle 10. This direction X more particularly corresponds to a longitudinal direction X extending from the front toward the rear of the cooling module 22. In the present application, an element which is positioned further forward or rearward than another element is referred to respectively as being “upstream” or “downstream”, in the longitudinal direction X of the cooling module 22. The front corresponds to the front of the motor vehicle 10 in the assembled state, or to the face of the cooling module 22 through which the air flow F is intended to enter the cooling module 22. The rear, for its part, corresponds to the rear of the motor vehicle 10, or to that face of the cooling module 22 through which the air flow F is intended to leave the cooling module 22.

The cooling module 22 comprises at least one heat exchanger 24, 26, 28, 29 as depicted in FIG. 2. The at least one heat exchanger 24, 26, 28, 29 is more particularly positioned within a set of heat exchangers 23. This set of heat exchangers 23 can more particularly comprise a first heat exchanger 24 (alternatively referenced to as a rear heat exchanger), a second heat exchanger 26 (alternatively referenced to as primary front heat exchanger), and a third heat exchanger 28 (alternatively referenced to as secondary front heat exchanger).

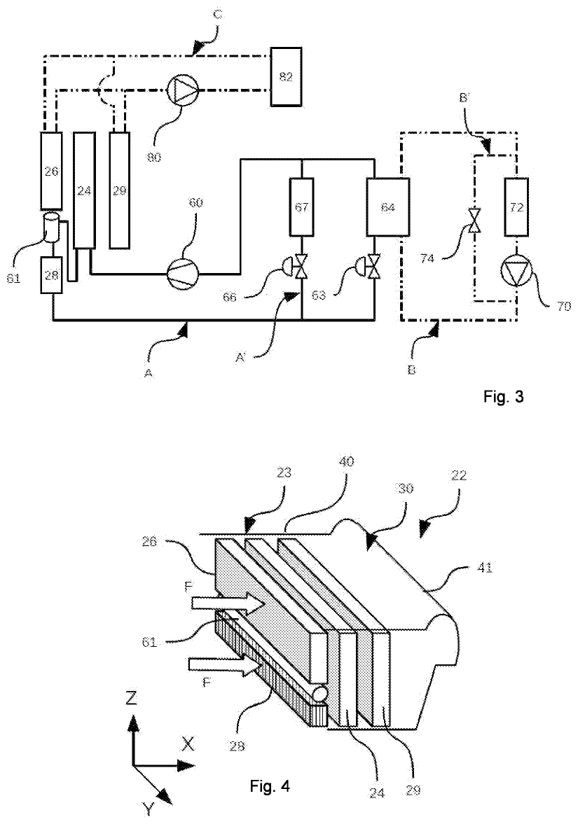

The first heat exchanger 24 is configured in particular to dissipate heat energy into the air flow F. This first heat exchanger 24 can more particularly be a condenser of a cooling circuit A (shown in FIG. 3), enabling the cooling of the batteries of the vehicle 10. This cooling circuit A can also be configured to provide thermal management of an air flow intended for the vehicle interior. In that case, the cooling circuit A can be an air conditioning circuit, notably a reversible air conditioning circuit. The first heat exchanger 24 can thus be an evaporator-condenser in the context of a reversible air conditioning circuit (not depicted).

The third heat exchanger 28 for its part is configured to be a sub-cooler connected within the air conditioning circuit A. This third heat exchanger 28 is thus also configured to dissipate heat energy into the air flow F.

The second heat exchanger 26 is also configured to release heat energy into the air flow F. This second heat exchanger 26 can more particularly be a radiator connected to a thermal management circuit C (visible in FIG. 3) for electrical elements such as the electric motor 12.

In the example illustrated in FIG. 2, the set of heat exchangers 23 comprises a fourth heat exchanger 29, which is likewise configured to release heat energy into the air flow F. This fourth heat exchanger 29 can more particularly likewise be a low-temperature radiator. This fourth heat exchanger 29 can be is connected to the thermal management circuit C in parallel with the second heat exchanger 26, as illustrated in FIG. 3. However, it is perfectly possible to conceive of an embodiment (not represented) in which the fourth heat exchanger 29 is connected to another thermal management circuit dedicated for example to the cooling of the power electronics.

Again according to FIG. 2, the cooling module 22 substantially comprises a housing or fairing 40 forming an internal duct between two opposite ends 40a, 40b, and inside which the set of heat exchangers 23 is positioned. This internal duct is preferably oriented parallel to the longitudinal direction X such that the upstream end 40a is oriented toward the front of the vehicle 10, facing the cooling opening 18, and such that the downstream end 40b is oriented toward the rear of the vehicle 10.

The cooling module 22 also comprises a collector housing 41 positioned downstream of the set of heat exchangers 23 in the longitudinal direction X of the cooling module 22. This first collector housing 41 comprises an outlet 45 for the air flow F. This first collector housing 41 thus makes it possible to recover the air flow passing through the set of heat exchangers 23, and to orient this air flow toward the outlet 45. The first collector housing 41 can be integral with the fairing 40 or else can be an added-on part secured on the downstream end 40b of said fairing 40.

The cooling module 22 also comprises at least one tangential fan, also known as a tangential-flow turbomachine 30, which is configured such as to generate the air flow F destined for the set of heat exchangers 23. The tangential-flow turbomachine 30 comprises a rotor or turbine (or tangential propeller), not represented. The turbine has a substantially cylindrical shape. The turbine advantageously comprises a plurality of stages of blades (or vanes). The turbine is mounted such as to rotate around an axis of rotation A, which for example is parallel to the direction Y. The diameter of the turbine is for example between 35 mm and 200 mm so as to limit its size. The turbomachine 30 is thus compact.

The tangential-flow turbomachine 30 can also comprise a motor 31 which is configured to rotate the turbine. The motor 31 is for example designed to drive the rotation of the turbine at a speed of between 200 rpm and 14 000 rpm. This notably makes it possible to limit the noise generated by the tangential-flow turbomachine 30.

The tangential-flow turbomachine 30 is preferably positioned in the first collector housing 41. The tangential-flow turbomachine 30 is then configured to aspirate air in order to generate the air flow F passing through the set of heat exchangers 23. The first collector housing 41 then forms a volute at the center of which the turbine 32 is positioned, and from which the evacuation of air at the outlet 45 of the first collector housing 41 allows the air flow F to exit.

In the example illustrated in FIG. 2, the tangential-flow turbomachine 30 is in a high position, in particular in the upper third of the first collector housing 41, preferably in the upper quarter of the first collector housing 41. This makes it possible in particular to protect the tangential-flow turbomachine 30 in case of submersion, and/or to limit the size of the cooling module 22 in its lower part.

It is nevertheless possible to conceive of the tangential-flow turbomachine 30 being in a low position, in particular in the lower third of the first collector housing 41. This would make it possible to limit the space taken up by the cooling module 22 in its upper part. Alternatively, the tangential-flow turbomachine 30 can be in a median position, in particular in the median third of the height of the first collector housing 41, for example for reasons of integration of the cooling module 22 into its surroundings.

In addition, in the example illustrated in FIG. 2, the tangential-flow turbomachine 30 operates with aspiration, i.e. it aspirates the ambient air so that the air passes through the set of heat exchangers 23. Alternatively, the tangential-flow turbomachine 30 can operate by blowing, blowing the air toward the set of heat exchangers 23. For this purpose, the tangential-flow turbomachine 30 will be positioned upstream of the set of heat exchangers 23.

The cooling module 22 can also comprise a second collector housing 42 positioned upstream of the set of heat exchangers 23. This second collector housing 42 comprises an inlet 42a for the air flow F coming from outside the vehicle 10. The inlet 42a can in particular be positioned facing the cooling opening 18. This inlet 42a can also comprise the protective grille 20. The second collector housing 42 can be integral with the fairing 40 or else be an attached component fastened to the upstream end 40a of said fairing 40.

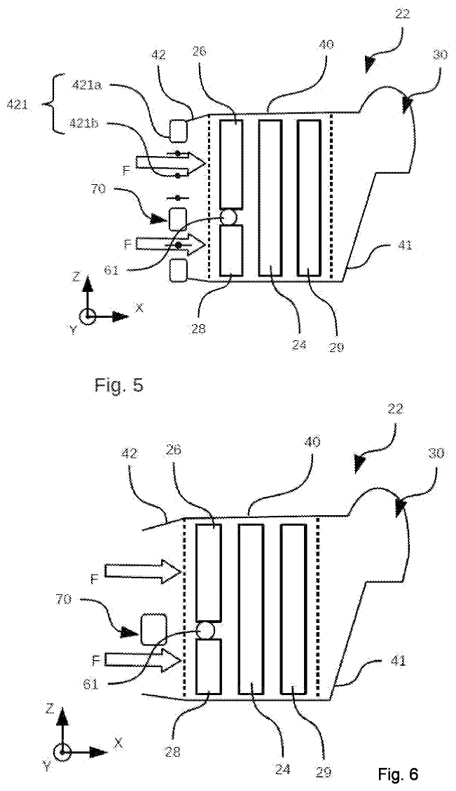

In addition, the inlet 42a of the second collector housing 42 can comprise a front-face shut-off device 421 (visible in FIG. 5), which device is configured to allow the air flow F coming from outside the vehicle 10 to pass through said first inlet 42a when said device is in an open state, and to shut off said first air-flow inlet 42a when said device is in a closed state. The front face shut-off device 421 can take various forms, such as, for example, the form of a plurality of shutter flaps 421b mounted so as to be able to pivot within a frame 421a between an open position and a closed position. The flaps 421b can be flaps of the flag type, but other types of flaps such as butterfly flaps can perfectly well be envisaged.

FIG. 3 shows a schematic representation of the cooling circuit A and of the thermal management circuit C to which circuits the first 24, second 26 and third 28 heat exchangers are connected.

A heat transport fluid is designed to circulate inside the thermal management circuit C, represented in broken line. The thermal management circuit C can thus comprise, in the direction of circulation of a heat transport fluid, a pump 80, a first cooler 82 and the second heat exchanger 26. The first cooler 82 can notably be a heat-exchange interface for example positioned in the vicinity of electrical elements such as the electric motor 12 and/or the power electronics, in order to manage the temperature thereof.

As mentioned above, in the example illustrated in FIG. 3, the thermal management circuit C can also comprise the third heat exchanger 29. The third heat exchanger 29 here is connected to the thermal management circuit C in parallel with the second heat exchanger 26.

In FIG. 3, the cooling circuit A is represented in solid line. A refrigerant is designed to circulate within this cooling circuit A. The cooling circuit A comprises, in the direction of circulation of the refrigerant, a compressor 60 and the first heat exchanger 24, configured to be a condenser designed to have the air flow F passing through it. Downstream of the first heat exchanger 24, the cooling circuit A comprises the third heat exchanger 28, configured to be a sub-cooler. Downstream of the third heat exchanger 28, the cooling circuit A comprises a first expansion device 63 and a second cooler 64 which is notably dedicated to the thermal management of the batteries. The second cooler 64 can be an evaporator for direct cooling of the batteries, or else, as illustrated in FIG. 3, it can be a bi-fluid heat exchanger arranged in conjunction on an appended loop B for indirect cooling of the batteries.

This appended loop B can in particular comprise a pump 70 and a thermal management interface 72, for example a cold plate, in contact with the batteries. The appended loop B can also comprise a bypass B′ for bypassing the fifth heat exchanger 67, and comprising a valve 74 in order for example to provide homogenization of the temperature of the batteries.

The cooling circuit A can comprise a bypass leg A′ connected in parallel with the first expansion device 63 and with the first cooler 64. This bypass leg A′ comprises a second expansion device 66 positioned upstream of a third cooler 67. This third cooler 67 can notably be an evaporator intended to have passing through it an air flow destined for the vehicle interior.

Between the first 24 and the third 28 heat exchanger, the cooling circuit A comprises a receiver-dryer 61. This receiver-dryer 61 is in particular connected within the cooling circuit A downstream of the first heat exchanger 24, between said first heat exchanger 24 and the third heat exchanger 28, in the direction of circulation of the refrigerant circulating in said cooling circuit A.

As shown by FIGS. 2 to 4, the third heat exchanger 28 is positioned, within the set of heat exchangers 23, the furthest upstream in the longitudinal direction X of said cooling module 22. This allows the latter to benefit from the “coolest” air of the air flow F. The third heat exchanger 28 can thus perform its function of supercooling the refrigerant circulating in the cooling circuit A efficiently. The coefficient of performance of the cooling circuit A is thus high, and its cooling power is for example sufficient to assure at the same time the cooling of an air flow destined for the vehicle interior and the cooling of the batteries.

Again as illustrated in FIGS. 2 to 4, the second heat exchanger 26 is positioned, within the set of heat exchangers 23, upstream of the first heat exchanger 24 in the longitudinal direction X of the cooling module 22, within the set of heat exchangers 23. More particularly, the second heat exchanger 26 and the third heat exchanger 28 can be positioned in the one same plane within the set of heat exchangers 23, upstream of the first heat exchanger 24 in the longitudinal direction X of the cooling module 22. This then allows the second heat exchanger 26 and the third heat exchanger 28 both to be as far upstream as possible in the longitudinal direction X of the cooling module 22. Thus, both the second heat exchanger 26 and the third heat exchanger 28 benefit from the “coolest” air in order to dissipate heat energy as efficiently as possible.

As a preference, the cumulative height of the second 26 and the third 28 heat exchangers is substantially equal to that of the first heat exchanger 24. This therefore makes it possible to maintain a set of heat exchangers 23 in which each layer or stratum of heat exchanger has similar dimensions. This also makes it possible to limit the number of heat exchangers through which the air flow F passes, thereby limiting the drops in pressure head. It is thus possible for example to add the fourth heat exchanger 29 downstream of the first heat exchanger 24 in the air flow F.

Still according to FIGS. 2 to 4, the third heat exchanger 28 is preferably positioned below the second heat exchanger 26. “Positioned below” is undestood to mean in this case that, when mounted within the motor vehicle 10, the third heat exchanger 28 is situated closer to the ground than the second heat exchanger 26.

As illustrated in FIG. 4, within the cooling module, the receiver-dryer 61 is positioned in an upstream part of the cooling module 22 considered in the longitudinal direction X extending from the front toward the rear of said cooling module 22. More specifically, the receiver-dryer 61 is positioned downstream of and facing a deflector element 70 (visible in FIGS. 5 and 6). This positioning of the receiver-dryer 61 behind a deflector element 70 makes it possible to limit the disruption caused to the air flow F by the receiver-dryer 61. Specifically, only the disturbances and turbulence caused by the deflector element 70 have an impact on the heat exchangers 24, 26, 28 and 29.

As illustrated in FIG. 4, the at least one heat exchanger 24, 26, 28, 29 positioned furthest upstream in the longitudinal direction X of said cooling module 22, in this instance the second heat exchanger 26, and the receiver-dryer 61 can be arranged in the one same plane. This notably makes it possible for the cooling module 22 to occupy a smaller amount of space. More specifically, the receiver-dryer 61 can be positioned in such a way that its axis, in this instance the transverse axis Y, is perpendicular to the axis Z of the height of said at least one heat exchanger 24, 26, 28, 29. The receiver-dryer 61 is therefore “lying down” below or else above said at least one heat exchanger 24, 26, 28, 29.

In instances in which the cooling module 22 comprises two heat exchangers, in this instance the second 26 and third 28 heat exchangers which are positioned in the one same plane and positioned furthest upstream in the longitudinal direction X of said cooling module 22, the receiver-dryer 61 can more particularly be positioned between said heat exchangers 26, 28, as illustrated in FIGS. 4 to 6.

As a preference, the deflector element 70 is an element that already exists within the motor vehicle 10 or within the cooling module 22. Thus, by siting the receiver-dryer 61 behind this element, the turbulence or disturbance affecting the air flow F is no greater than it already was.

According to a first alternative form illustrated in FIG. 5, the deflector element 70 can be a crossmember of a frame 421a of a front-face shutoff device 421 positioned upstream of the at least one heat exchanger 24, 26, 28, 29. The front-face shutoff device 421 here comprises a portion referred to as upper portion facing the second heat exchanger 26 and a portion referred to as lower portion facing the third heat exchanger 28. The receiver-dryer 61, positioned between the second 26 and third 28 heat exchangers, is therefore masked by the crossmember of the frame 412a separating these two portions. The air flow F can therefore flow in these two portions without being disturbed by the receiver-dryer 61.

According to a second alternative form illustrated in FIG. 6, the deflector element 70 can be a cross-beam of the chassis of the motor vehicle 10 positioned upstream of the at least one heat exchanger 24, 26, 28, 29. Just as in the first alternative form, the cross-beam of the chassis of the motor vehicle 10 defines a portion referred to as upper portion facing the second heat exchanger 26 and a portion referred to as lower portion facing the third heat exchanger 28. The receiver-dryer 61, positioned between the second 26 and third 28 heat exchangers, is therefore masked by the cross-beam demarcating these two portions. The air flow F can therefore flow in these two portions without being disturbed by the receiver-dryer 61.

It can thus be clearly seen that siting the receiver-dryer 61 downstream of and facing a deflector element 70 allows better circulation of the air flow F and therefore optimal performance for the various heat exchangers and allows the cooling module 22 to occupy a smaller amount of space.

What is claimed is:

1. A cooling module for an electric or hybrid motor vehicle, configured to have an air flow passing therethrough, comprising:
a primary front heat exchanger;
a receiver dryer positioned in an upstream part of the cooling module considered in a longitudinal direction extending from a front toward a rear of the cooling, module; and
a deflector element;
wherein, in the longitudinal direction of the cooling module, the receiver dryer is positioned downstream of and facing the deflector element.

2. The cooling module as claimed in claim 1, wherein the primary front heat exchanger is positioned furthest upstream in the longitudinal direction of said cooling module, the primary front heat exchanger and the receiver dryer being arranged in the etisame plane being perpendicular to the longitudinal direction.

3. The cooling module as claimed in claim 1, wherein a receiver-drier extension axis, height axis of the primary front heat exchanger and the longitudinal direction are perpendicular to each other.

4. The cooling module as claimed in claim 1, further comprising a front-face shutoff with a frame positioned upstream of the primary front heat exchanger, wherein the deflector element is a crossmember of the frame.

5. (canceled)

6. The cooling module as claimed in claim 1, further comprising a secondary front heat exchanger, the primary front heat exchanger and the secondary front heat exchanger being positioned in the same plane being perpendicular to the longitudinal direction, in the most upstream position in the longitudinal direction of said cooling module, the receiver dryer being positioned between the primary front heat exchanger and the secondary front heat exchanger.

7. The cooling module as claimed in claim 1, further comprising a cooling circuit, a secondary front heat exchanger and a rear heat exchanger, wherein:
the receiver-dryer is connected within the cooling circuit,
the rear heat exchanger is a condenser connected within the cooling circuit,
the primary front heat exchanger is a low-temperature radiator for connecting within a thermal management circuit, and
the secondary front heat exchanger is a sub-cooler connected within the cooling circuit.

8. (canceled)

9. (canceled)

10. (canceled)

11. A motor vehicle comprising:
a cooling module for an electric or hybrid motor vehicle, configured to have an air flow passing therethrough, including:
a primary front heat exchanger;
a receiver dryer positioned in an upstream part of the cooling module considered in a longitudinal direction extending from a front toward a rear of the cooling module; and
a deflector element;
wherein, in the longitudinal direction of the cooling module, the receiver-dryer is positioned downstream of and facing the deflector element;
a chassis;
wherein the deflector element is a cross-beam of the chassis, positioned upstream of the primary front heat exchanger.
